(19) United States
(12) Patent Application Publication
(10) Pub. No.: US 2018/0368458 A1
(43) Pub. Date: Dec. 27, 2018

(54) TIME RELEASE VITAMINS AND MINERALS IN EDIBLE OILS

(71) Applicant: CORR-JENSEN INC., New York, NY (US)

(72) Inventors: Tyler O. White, Greenwood, SC (US); Matthew Hesse, New York, NY (US)

(21) Appl. No.: 15/741,411

(22) PCT Filed: Feb. 17, 2017
(86) PCT No.: PCT/US2017/018344

§ 371 Date: Jan. 2, 2018

Related U.S. Application Data
(60) Provisional application No. 62/296,299, filed on Feb. 17, 2016.

(51) Int. Cl. A23L 33/15; A23L 29/00; A23D 9/007; A23L 33/115

(52) U.S. Cl. CPC A23L 33/15; A23L 29/04; A23L 33/16; A23L 33/115; A23D 9/007

(57) ABSTRACT

A nutrition enhancing composition comprising (a) an oil phase comprising one or more fish oils and optionally one or more oil soluble vitamins and/or minerals, (b) controlled release beads comprising one or more vitamins and/or minerals, wherein the controlled release beads are incorporated into said one or more edible oils and optionally (c) an immediate release component comprising at least one performance enhancing component.

### CROSS REFERENCE TO RELATED APPLICATIONS

This application depends from and claims priority to U.S. Provisional Application No. 62/296,299 filed Feb. 17, 2016, the entire contents of which are incorporated herein by reference.

### FIELD

The invention relates to nutrition and athletic endurance and performance. More specifically, compositions and methods are provided that enhance nutrition.

### BACKGROUND

Nutritional requirements play a key role in overall health, normal cell function, growth and development, as well as improving athlete endurance and performance. Increasing attention has been paid to understanding the role of various nutrients on overall human health and performance in athletic events. There remains, however, a need in the art to provide a supply of nutrients to individuals in the more efficaciously to allow for improved bioavailability and/or usability by a subject.

### SUMMARY

It is understood that both the following summary and the detailed description are exemplary and explanatory and are intended to provide further explanation of the disclosure as claimed. Neither the summary nor the description that follows is intended to define or limit the scope of the disclosure to the particular features mentioned in the summary or description.

One object is to provide a sustained and controlled supply of nutrients to individuals without the necessity of excess food intake so as to support or improved athletic performance, nutrition, or other desired outcome in a subject such as an athlete, optionally a human athlete. This object is achieved in the present disclosure that provides a nutrition enhancing composition. In certain aspects, the nutrition enhancing composition includes (a) an oil phase comprising one or more edible oils and optionally one or more oil soluble vitamins, one or more oil soluble minerals, or a combination thereof, (b) controlled release beads comprising one or more vitamins, one or more minerals, or a combination thereof, wherein the controlled release beads are incorporated into said one or more edible oils, and optionally (c) an immediate release component comprising at least one performance enhancing supplement.

Another aspect provides a process for enhancing nutrition in a subject. The process comprises administering to the subject a nutrition enhancing composition and enhancing nutrition in said subject by said step of administering. The composition comprises: (a) an oil phase comprising one or more edible oils and optionally one or more oil soluble vitamins, one or more oil soluble minerals, or a combination thereof, (b) controlled release beads comprising one or more vitamins, one or more minerals, or a combination thereof, wherein the controlled release beads are incorporated into said one or more edible oils, and optionally (c) an immediate release component comprising at least one performance enhancing supplement.

### DETAILED DESCRIPTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the compositions or processes are described as using specific materials or an order of individual steps, it is appreciated that materials or steps may be interchangeable such that the description of the invention may include multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular aspect only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Provided are compositions that include (a) an oil phase comprising one or more edible oils and optionally one or more oil soluble vitamins and/or minerals for immediate release, and (b) controlled release beads comprising one or more vitamins, one or more minerals, or a combination thereof, for timed released (e.g. sustained release, delayed release, or a combination of sustained and delayed release), and optionally (c) an immediate release component comprising at least one performance enhancing supplement. Such compositions can be used for nutrition enhancement, as well as improving athlete endurance and performance. Additionally, such compositions can be used for:
Immediate or timed release sleep recovery with time release melatonin/antioxidants to fall and stay asleep through the night (e.g., comprising melatonin, vitamin C, super fruits such as blueberry and acai, etc.);
Immediate or timed release metabolism boosters for weight loss (e.g. comprising green tea, citrus aurantium, citrus sinensis, chromium, etc.);
Immediate or timed release appetite suppressants to curb appetite in both the short term and over the course of the day (e.g. comprising garcinia cambogia, hoodia gordonii, 5-HTP, etc); or
Immediate or timed release multi vitamin nutritional supplement to supply nutrients throughout the day.

As such, according to some aspects, a composition includes (a) an oil phase comprising one or more edible oils and optionally one or more oil soluble vitamins, one or more oil soluble minerals, or a combination thereof, (b) a controlled release component or optionally an immediate release component comprising one or more vitamins, one or more minerals, or a combination thereof, and optionally (c) an immediate release component comprising at least one performance enhancing supplement. The (a) oil phase provides for immediate release one or more edible oils and the optional one or more oil soluble vitamins, one or more oil soluble minerals, or a combination thereof for enhancing nutrition and/or exercise performance that are rapidly bioavailable and capable of rapid function. As the body stores, rather than excretes, excess oil soluble vitamins and minerals, the one or more oil soluble vitamins, one or more oil soluble minerals, or a combination thereof can be incorporated in the immediate release oil phase of the composition.

In certain aspects, the (a) immediate release oil phase comprises one or more edible oils and optionally one or more oil soluble vitamins and/or minerals. The (b) controlled release component comprises one or more vitamins, one or minerals, or a combination thereof, formulated for timed release. In certain aspects, the (b) controlled release component or immediate release component comprises one or more vitamins, one or more minerals, or a combination thereof formulated for sustained release, delayed release, or a combination of both sustained release and delayed release, such that the extended release component provides a sustained nutrition and/or performance, a latter nutrition and/or performance burst, or combinations thereof. Thus, in some aspects, the (b) controlled release component or immediate release component is in the form of a plurality of beads, including extended release beads, delayed release beads, beads providing both extended and delayed release, or combinations thereof. The optional (c) immediate release component comprises at least one performance enhancing component is designed such that, upon ingestion, maximum exposure of the at least one performance enhancing component from the composition to body tissues occurs in the minimum period of time. In certain aspects, the (c) second immediate release component comprises an immediate release outer coating of the (b) controlled release beads, including extended release beads, delayed release beads, beads providing both extended and delayed release, and combinations thereof. In some aspects, the (c) immediate release component comprises immediate release beads comprising at least one performance enhancing component. An immediate release bead is one that excludes components or arrangements of components that provide delayed or otherwise timed release of the performance enhancing component or other desired component therein. In some aspects, the nutrition and/or performance enhancing immediate and controlled release composition is an oral dosage form. In particular aspects, the nutrition and/or performance enhancing immediate and controlled release composition is a liquid capsule, optionally a two piece liquid capsule.

As used herein, the term “performance” means performance in athletics. Performance means strong, precise, controlled movements over the time desired by an athlete to achieve a particular result of strength, speed, power and/or precision. “Athlete” is herein defined as a mammal who performs such movements, either in competition, for recreation, or in studies. Athletes illustratively include but are not limited to cyclists, swimmers, bodybuilders, racehorses, racing dogs, and the like. An increase in athletic performance is measured as higher power output, more stamina, or faster speed, optionally in combination with precision of movement or an increase in frequency of performance or movements.

In some aspects, an immediate and controlled release nutrition and/or performance enhancing composition is provided. In certain aspects, the composition comprises an immediate release oil phase comprising one or more edible oils. The compositions further comprises controlled release beads comprising one or more vitamins, one or more minerals, or a combination thereof, wherein the controlled release beads are incorporated into said one or more edible oils of the oil phase. In aspects, the immediate release oil phase further comprises one or more oil soluble vitamins, one or more oil soluble minerals, or a combination thereof.

In aspects, the immediate and controlled release nutrition and/or performance enhancing composition includes an immediate release oil phase comprising one or more edible oils and one or more oil soluble vitamins, one or more oil soluble minerals, or a combination thereof. The term “immediate release” is the release of the at least one oil phase, including the one or more edible oils and one or more oil soluble vitamins, one or more oil soluble minerals, or a combination thereof when included in the oil phase, from the compositions where the rate of release is not retarded by means of a controlled release matrix, controlled release coating, or other such means. In certain aspects, the oil phase can be in a liquid or paste-like state at 25° C.

In some aspects, the one or more edible oils and one or more oil soluble vitamins, one or more oil soluble minerals, or a combination thereof of the oil phase are suitable to enhance nutrition and/or exercise performance. In certain aspects, the oil phase can comprise edible oils or components thereof, such as fatty acids and medium chain triglycerides. In some aspects, an edible oil is a fish oil, or optionally a bioactive component thereof. As used herein, “fish oils” are oils that are obtained either directly or indirectly from one or more aquatic life forms. “Fish oil” can be derived from fresh or salt water fish, shellfish, or algae. In certain aspects, fish oils are obtained from oily fish. Fish oils are high in one or more of omega-3 fatty acids, such as docosahexaneoic acid, eicosapentaenoic acid docosapentaenoic acid, eicosatetraenoic acid, moroctic acid and heneicosapentenoic acid relative to non-fish oils. Omega-3 fatty acids are beneficial for prevention of cardiovascular pathology, for reversal of atherosclerosis, for inhibition of tumor formation, and for regulation of cholesterol. In certain aspects, the one or more fish oils of the oil phase of the composition comprises docosahexaneoic acid and eicosapentaenoic acid.

It is appreciated that some aspects may include more than one edible oil, optionally 2, 3, 4, 5, 6, or more edible oils or bioactive components thereof. Illustrative additional or substitutable edible oils include, but are not limited to vegetable and plant oils, essential oils, and CO₂ extracts. Illustrated vegetable and plant oils include, but are not limited to, evening primrose oil, black currant seed oil, borage oil, borage seed oil, safflower oil, safflower seed oil, sunflower oil, sunflower seed oil, sesame seed oil, peanut oil, walnut oil, almond oil, olive oil, olive seed oil, avocado oil, avocado seed oil, pumpkin seed oil, corn oil, cod liver oil, soy oil, soybean oil, coconut oil, palm oil, palm kernel oil, rapeseed oil, flaxseed (linseed) oil, cotton seed oil, tung oil, palmolein oil, mustard seed oil, oiticica oil and castor oil, arachidonic acid, lecithin, conjugated linoleic acids, and combinations thereof. Illustrative essential oils include, but are not limited to, ajowan oil, aniseed oil, atlas cedarwood oil, bay laurel oil, bergamot oil, cajeput oil, caraway oil, cinnamon chamomile oil, clove oil, cumin oil, cypress oil, Echinacea oil, elemi oil, eucalyptus oil, fennel oil, fir oil, frankincense oil, goldenseal oil, grapefruit oil, helichrysum oil, hyssop oil, jasmine oil, juniper oil, kanuka oil, lavender oil, lemon oil, lemongrass oil, manuka oil, marjoram oil, melissa oil, myrrh oil, myrtle oil, niaouli oil, nutmeg oil, orange oil, oregano oil, peppermint oil, petitgrain oil, pine oil, ravensara oil, rose geranium oil, rosewood oil, sage oil, sandlewood oil, savory oil, spruce oil, tea tree oil, thyme oil, valerian oil, vetiver oil, verbena oil, vervain oil, ylang ylang oil, and combinations thereof. Illustrative CO₂ extracts include, but are not limited to, agarwood CO₂ extract, ambrette seed CO₂ extract, angelica root CO₂ extract, butter CO₂ extract, calendula CO₂ extract, caraway CO₂ extract, cardamom CO₂ extract, chamomile CO₂ extract, champaca CO₂ extract, cinnamon bark CO₂ extract, coconut pulp CO₂ extract, coffee bean CO₂ extract, coriander seed CO₂ extract, coriander seed CO₂ extract, fenugreek CO₂ extract, frankincense CO₂ extract, galangal CO₂ extract, ginger CO₂ extract, jasmine CO₂ extract, juniper berry CO₂ extract, kava kava CO₂ extract, parsley CO² extract, patchouli CO₂ extract, pomegranate CO₂ extract, raspberry seed CO₂ extract, rose hip seed CO₂ extract, sea buckthorn CO₂ extract, spikenard CO₂ extract, turmeric CO₂ extract, vanilla bourbon CO₂ extract, and combinations thereof. Edible oils are commercially available from sources known by those of skill in the art.

In certain aspects, the one or more edible oils of the oil phase of the composition can range from about 0.5 to about 90% by weight. In other aspects, the one or more edible oils of the oil phase of the composition can range from about 5% to about 50% by weight, including any value or range therebetween.

In aspects, the one more one or more oil soluble vitamins, one or more oil soluble minerals, or a combination thereof, comprises at least one of Vitamin A (optionally as Retinyl Palmitate), Vitamin D (optionally as Cholecalciferol), Vitamin E (optionally as D-Alpha Tocopherol), Vitamin K (optionally as Phytonadione), Vitamin F and various mixtures or other combinations thereof. Oil soluble vitamins and oil soluble minerals are commercially available from sources known by those of skill in the art.

The one or more oil soluble vitamins, one or more oil soluble minerals, or a combination thereof in the oil phase can range from about 0.1 to about 99% by weight based on the total weight of the oil phase, including any value and range therebetween. In other aspects, one or more oil soluble vitamins, one or more oil soluble minerals, or a combination thereof in the oil phase can range from about 0.5 to about 40% by weight based on the total weight of the oil phase, including any value or range therebetween.

In certain aspects, the oil phase of the composition may further comprise one or more known additives such as preservative, flavorants, and colorants. In certain aspects, such additives, the amount thereof to be added optionally ranges from about 0.01 to about 5% by weight based on the total amount of the oil phase of the composition, including any value or range therebetween.

Exemplary preservatives that may be included in the oil phase of the composition include sodium benzoate, benzoic acid, potassium sorbate, salts of edetate (also known as salts of ethylenediaminetetraacetic acid, or EDTA, such as disodium EDTA), parabens (e.g., methyl, ethyl, propyl or butyl-hydroxybenzoates, etc.), and sorbic acid. Other chelating agents, e.g., nitrilotriacetic acid (NTA); ethylenediaminetetracetic acid (EDTA), hydroxyethylethylenediaminetriacetic acid (HEDTA), diethylenetriaminepentaacetic acid (DPTA), 1,2-Diaminopropanetetraacetic acid (1,2-PDTA); 1,3-Diaminopropanetetraacetic acid (1,3 -PDTA); 2,2-ethylenedioxybis [ethyliminodi(acetic acid)] (EGTA); 1,10-bis(2-pyridylmethyl)-1,4,7,10-tetraazadecane (BPTETA); ethylenediamine (EDAMINE); Trans-1,2-diaminocyclohexane-N,N,N′,N′-tetraacetic acid (CDTA); ethylenediamine-N,N′-diacetate (EDDA); phenazine methosulphate (PMS); 2,6-Dichloro-indophenol (DCPIP); Bis(carboxymethyl)diaza-18-crown-6 (CROWN); porphine; chlorophyll; dimercaprol (2,3-Dimercapto-1-propanol); citric acid; tartaric acid; fumaric acid; malic acid; and salts thereof can be utilized as preservatives. Each preservative must be evaluated in each formulation to assure the compatibility and efficacy of the preservative. Methods for evaluating the efficacy of preservatives in compositions and formulations are known and routine to those skilled in the art.

Exemplary flavorings that may be included in the oil phase of the composition include both natural and artificial flavors, and mints such as peppermint, menthol, artificial vanilla, chocolate, cinnamon, various fruit flavors, both individual and mixed, essential oils (i.e. thymol, eucalyptol, menthol and methyl salicylate), combinations thereof, and the like.

In certain aspects, the immediate and controlled release nutrition and/or performance enhancing composition further comprises a controlled release component comprising one or more vitamins, one or more minerals, or a combination thereof formulated for sustained release, delayed release, or both sustained release and delayed release, such that the extended release component provides a sustained nutrition and/or performance, a latter nutrition and/or performance burst, or combinations thereof. In some aspects, the controlled release component comprises extended release beads, delayed release beads, beads providing both extended and delayed release, or combinations thereof. As described previously, in aspects the controlled release component, including extended release beads, delayed release beads, beads providing both extended and delayed release, or combinations thereof, are incorporated into said one or more edible oils of the oil phase.

In some aspects, the one or more vitamins, one or more minerals, or a combination thereof of the controlled release component (including extended release beads, delayed release beads, or beads providing both extended and delayed release) can comprise one or more water soluble vitamins, one or more water soluble minerals, one or more oil soluble vitamins, one or more oil soluble minerals, or any combination thereof. In certain aspects, the one or more water soluble vitamins, one or more water soluble minerals, or combinations thereof can comprise at least one of vitamin B1 (optionally in the form of thiamine mononitrate), vitamin B2 (optionally in the form of riboflavin), vitamin B3 (optionally in the form of niacin and/or inositol hexanicotinate), vitamin B5 (optionally in the form of pantothenic acid and/or calcium D-pantothenic acid), vitamin B6 (optionally in the form of pyridoxine HCl), folic acid (optionally in the form or folate), vitamin B12 (optionally in the form of methylcobalamin), vitamin C (optionally in the form of ascorbic acid), biotin, calcium, iron (optionally in the form of ferrous sulfate monohydrate and/or ferrous sulfate), phosphorus, sulfur, zinc (optionally in the form of zinc oxide), copper (optionally in the form of cupric oxide), iodine (optionally in the form of potassium iodine), manganese (optionally in the form of manganese gluconate), chromium (optionally in the form of chromium chelate), molybdenum (optionally in the form of molybdenum chelate), selenium (optionally in the form of sodium selenate), sensoril® ashwagandha (withania smnifera) (Root, Leaf), huperzine A 1% (huperzia serrata) (whole herb), alpha-GPC (alpha lycerylphosphorylcholine), cognizin® citicoline, saw palmetto serenoa repens (Fruit) (3-8% Free Fatty Acids), lycopene, citicoline, choline, fluoride, chloride, potassium, sodium, magnesium, boron (optionally in the form of boron amino acid chelate), and various mixtures or other combinations thereof. Water soluble vitamins and minerals are commercially available from sources known by those of skill in the art. In some aspects, the one or more oil soluble vitamins, one or more oil soluble minerals, or combinations thereof can comprise can comprise at least one of vitamin A (optionally as retinyl palmitate), vitamin D (optionally as cholecalciferol), vitamin E (optionally as D-alpha tocopherol), vitamin K (optionally as phytonadione), vitamin F and various mixtures or other combinations thereof. Oil soluble vitamins and/or minerals are commercially available from sources known by those of skill in the art.

In some aspects, the controlled release component comprises extended release beads. The term “extended release” refers to the gradual release of the one or more vitamins and minerals from the extended release beads of the composition over an extended period of time, optionally greater than 30 minutes. With extended release, the rate of release of the one or more vitamins, the one or more minerals, or a combination thereof, from the extended release beads is reduced in order to maintain therapeutic activity of the one or more vitamins, the one or more minerals, or a combination thereof for a longer period of time. As described herein, a controlled release bead that provides “extended release” (e.g. an “extended release” bead) preferably releases not less than 80% of the one or more vitamins, the one or more minerals, or a combination thereof, in about 8 hours, e.g., in about 8 hours, in about 6 hours, in about 4 hours, in about 2 hours, in about 1 hour, in about 50 minutes, in about 40 minutes, or any value or range therebetween. In certain aspects, an “extended release” bead preferably releases not more than 20% of the one or more vitamins, the one or more minerals, or a combination thereof in about 1 hour, in about 50 minutes, in about 40 minutes, in about 30 minutes, in about 20 minutes, or any value or range therebetween. In other aspects, an “extended release” bead preferably releases not more than 10% of the one or more vitamins and/or minerals in about 1 hour, in about 50 minutes, in about 40 minutes, in about 30 minutes, in about 20 minutes, or any value or range therebetween.

In some aspects, the controlled release component comprises delayed release beads. As described herein, a controlled release bead that provides “delayed release” (e.g. a “delayed release” bead) refers to a controlled release bead that provides for a modified release in which the release of the one or more vitamins and/or minerals from the beads is delayed after oral administration for a finite period of time after which release of the one or more vitamins and/or minerals is unhindered.

In some aspects, the controlled release component comprises beads that provide for both extended and delayed release. Such beads provide for a modified release in which the release of the one or more vitamins and minerals from the beads is delayed after oral administration for a finite period of time after which gradual release of the one or more vitamins and minerals from the controlled release beads of the composition occurs over an extended period of time, as described above.

In certain aspects, the controlled release beads, including extended release beads, delayed release beads, or beads providing both extended and delayed release, comprise an inert core and a nutrient layer coating the inert core. The inert core of the controlled release beads can comprise at least one of celluloses, starches, saccharides, or mixtures thereof. In certain aspects, the inert core of the controlled release beads is spherical. In other aspects, the inert core of the controlled release beads is a sugar sphere, as are known in the art and commercially available.

In some aspects, the nutrient layer of the controlled release beads comprises one or more vitamins, one or more minerals, or a combination thereof. In certain aspects, the nutrient layer can comprise one or more water soluble vitamins, one or more water soluble minerals, one or more oil soluble vitamins, one or more oil soluble minerals, or combinations thereof. In certain aspects, the one or more water soluble vitamins, one or more water soluble minerals, or combinations thereof can comprise at least one of vitamin B1 (optionally in the form of thiamine mononitrate), vitamin B2 (optionally in the form of riboflavin), vitamin B3 (optionally in the form of niacin and/or inositol hexanicotinate), vitamin B5 (optionally in the form of pantothenic acid and/or calcium D-pantothenic acid), vitamin B6 (optionally in the form of pyridoxine HCl), folic acid (optionally in the form or folate), vitamin B12 (optionally in the form of methylcobalamin), vitamin C (optionally in the form of ascorbic acid), biotin, calcium, iron (optionally in the form of ferrous sulfate monohydrate and/or ferrous sulfate), phosphorus, sulfur, zinc (optionally in the form of zinc oxide), copper (optionally in the form of cupric oxide), iodine (optionally in the form of potassium iodine), manganese (optionally in the form of manganese gluconate), chromium (optionally in the form of chromium chelate), molybdenum (optionally in the form of molybdenum chelate), selenium (optionally in the form of sodium selenate), sensoril® ashwagandha (withania smnifera) (Root, Leaf), huperzine A 1% (huperzia serrata) (whole herb), alpha-GPC (alpha lycerylphosphorylcholine), cognizin® citicoline, saw palmetto serenoa repens (Fruit) (3-8% Free Fatty Acids), lycopene, citicoline, choline, fluoride, chloride, potassium, sodium, magnesium, boron (optionally in the form of boron amino acid chelate), and various mixtures or other combinations thereof. Water soluble vitamins and minerals are commercially available from sources known by those of skill in the art. In some aspects, the one or more oil soluble vitamins, one or more oil soluble minerals, or combinations thereof can comprise can comprise at least one of vitamin A (optionally as retinyl palmitate), vitamin D (optionally as cholecalciferol), vitamin E (optionally as D-alpha tocopherol), vitamin K (optionally as phytonadione), vitamin F and various mixtures or other combinations thereof. Oil soluble vitamins and/or minerals are commercially available from sources known by those of skill in the art.

In one aspect, the nutrient layer of the controlled release beads can be applied, e.g., as an aqueous suspension or dispersion, over the inert core, a binding layer, or a seal layer of the controlled release beads (including extended release beads, delayed release beads, or beads providing both extended and delayed release), and forms a separate layer thereon.

In certain aspects, the controlled release beads, including extended release beads, delayed release beads, or beads providing both extended and delayed release, further comprise a seal film layer. In further aspects, the seal film layer comprises a sealer. Suitable sealers include, but are not limited to, celluloses such as hydroxypropylmethylcellulose, hydroxypropyl cellulose, microcrystalline cellulose and carboxymethyl-cellulose sodium, polyvinylpyrrolidone, polyethylene glycol, starches, and combinations thereof. In certain aspects, the seal film layer coats the nutrient layer. In further aspects, the seal film layer directly coats the nutrition layer. In one aspect, the seal film layer can be applied, e.g., as an aqueous suspension or dispersion, over the nutrient layer, a binder layer, or inert core of the controlled release beads (including extended release beads, delayed release beads, or beads providing both extended and delayed release), and forms a separate layer thereon.

In certain aspects, the controlled release beads, including extended release beads, delayed release beads, or beads providing both extended and delayed release, further comprise at least one binder. Binders are substances that are useful in holding other excipients or active ingredients together as solids. Suitable binders include, but are not limited to, celluloses such as hydroxypropylmethylcellulose, hydroxypropyl cellulose, microcrystalline cellulose and carboxymethyl-cellulose sodium, polyvinylpyrrolidone, polyethylene glycol, starches, and combinations thereof. In certain aspects, the at least one binder is included in the nutrient layer. In other aspects, the at least one binder can be included in a binder layer of the controlled release beads. In one aspect, the binder layer can be applied, e.g., as an aqueous suspension or dispersion, over the nutrient layer, seal film layer, or inert core of the controlled release beads (including extended release beads, delayed release beads, or beads providing both extended and delayed release), and forms a separate layer thereon.

The one or more vitamins and/or minerals of the controlled release beads, including extended release beads, delayed release beads, or beads providing both extended and delayed release, is present to provide an in vivo concentration effective to enhance nutrition and/or to improve athletic performance. In certain aspects, the one or more vitamins and/or minerals of the controlled release beads, including extended release beads, delayed release beads, or beads providing both extended and delayed release, is optionally present at a weight percent of the performance enhancing immediate and extended release powder blend of about 5% to about 95%, or any value or range therebetween. For example, the one or more vitamins and/or minerals of the controlled release beads (including extended release beads, delayed release beads, or beads providing both extended and delayed release) is optionally present at a weight percent of about 1% to about 15%, about 1% to about 25%, about 10% to about 35%, about 25% to about 45%, about 25% to about 55%, or any value or range therebetween. Optionally, the one or more vitamins, the one or more minerals, or combinations thereof of the controlled release beads (including extended release beads, delayed release beads, or beads providing both extended and delayed release) is present at 1% to 55% by weight, including any value or range therebetween. Optionally, the one or more vitamins, one or more minerals, or combination thereof is present at 0.1% to 20% by weight, including any value or range therebetween.

In some aspects, the controlled release beads, including extended release beads, delayed release beads, or beads providing both extended and delayed release, can comprise one or more barrier coatings. A barrier coat comprises a water-permeable, water-insoluble, non-ionic polymer or co-polymer that confers either extended release or delayed release properties to the beads. In one aspect, a barrier coat can be applied, e.g., as an aqueous suspension or dispersion, over the controlled release beads, including extended release beads, delayed release beads, or beads providing both extended and delayed release, and forms a separate layer thereon. In some aspects, a barrier coat is directly over a nutrient layer (or seal layer overlying a nutrient layer) of the controlled release beads, including extended release beads, delayed release beads, or beads providing both extended and delayed release, i.e., there are no intervening layers. Depending upon the polymeric material selected, the barrier coat polymer or co-polymer may be cured (e.g., poly-vinyl acetate or ethylcellulose-based coatings). In certain aspects, a poly-vinyl acetate based coating may further include a plasticizer. In certain aspects, the barrier coating can comprise poly-vinyl acetate-based coatings, ethylcellulose-based coatings, hydrophobic shellac coatings, or enteric coatings, as are known in the art.

In certain aspects, a barrier coating comprises a hydrophobic material, including but not limited to cellulosic materials and polymers (including alkyl celluloses, such as hydroxyalkyl celluloses), acrylic polymers, or combinations thereof. Such hydrophobic coatings can be included in the controlled release beads to provide for the gradual release of the one or more vitamins and minerals from the controlled release beads of the composition over an extended period of time, and thus can be used to produce extended release beads and beads providing both extended and delayed release. By way of example, a suitable alkyl cellulosic polymer includes, but is not limited to, ethylcellulose, such as Aquacoat® (FMC Corp., Philadelphia, Pa., U.S.A.) and Surelease® (Colorcon, Inc., West Point, Pa., U.S.A.). Suitable hydroxyalkyl celluloses include, but are not limited to a hydroxy (C1 to C6) alkyl cellulose, such as hydroxypropylcellulose, hydroxypropylmethylcellulose, and hydroxyethylcellulose. Suitable acrylic polymers include, but are not limited to, acrylic acid and methacrylic acid copolymers, methyl methacrylate copolymers, ethoxyethyl methacrylates, cyanoethyl methacrylate, poly(acrylic acid), poly(methacrylic acid), methacrylic acid alkylamide copolymer, poly(methyl methacrylate), polymethacrylate, poly(methyl methacrylate) copolymer, polyacrylamide, aminoalkyl methacrylate copolymer, poly(methacrylic acid anhydride), and glycidyl methacrylate copolymers. In aspects, the barrier coating comprising a hydrophobic material can be applied, e.g., as an aqueous suspension or dispersion, over the nutrient layer or seal film layer of the controlled release beads (including extended release beads, or beads providing both extended and delayed release), and forms a separate layer thereon. In aspects the hydrophobic barrier provides for the gradual release of the one or more vitamins and minerals from the nutrient layer of the controlled release beads of the composition over an extended period of time.

In certain aspects that include a barrier coating comprising a hydrophobic material, particularly cellulosic materials and polymers (including alkylcelluloses), acrylic polymers, or combinations thereof, the barrier coating can further comprise a plasticizer. Suitable plasticizers for barrier coatings comprising alkylcelluloses, including ethylcellulose, include but are not limited to water insoluble plasticizers such as dibutyl sebacate, diethyl phthalate, triethyl citrate, tributyl citrate, and triacetin. Suitable plasticizers for barrier coatings comprising acrylic polymers include, but are not limited to citric acid esters such as triethyl citrate NF XVI, tributyl citrate, dibutyl phthalate, and polyethylene glycols, propylene glycol, diethyl phthalate, castor oil, and triacetin.

In certain aspects, a barrier coating can comprise an enteric coating. Enteric coatings can be included in the controlled release beads to produce delayed release beads and beads providing both extended and delayed release. Suitable enteric coating materials include one or more polymers, for example but not limited to, methacrylic acid copolymers, cellulose acetate butyrate, cellulose acetate trimellitate, carboxymethylethylcellulose, shellac, Eudragit L, Eudragit S (Rohm Pharma), hydroxypropyl methylcellulose acetate succinate, hydroxypropyl methylcellulose phthalate, polyvinyl acetate phthalate, cellulose acetate phthalate, and combinations thereof. In aspects, the barrier coating comprising an enteric coating can be applied, e.g., as an aqueous suspension or dispersion, over the nutrient layer or seal film layer of the controlled release beads (including delayed release beads, or beads providing both extended and delayed release), and forms a separate layer thereon. In such aspects, the enteric barrier provides for the delayed release of the one or more vitamins and minerals from the nutrient layer of the controlled release beads of the composition over an extended period of time. In aspects, the barrier coating comprising an enteric coating can be applied, e.g., as an aqueous suspension or dispersion, over a barrier coating comprising a hydrophobic material and forms a separate layer thereon, with the hydrophobic barrier overlying a nutrient layer or a seal film layer of the controlled release beads (including beads providing both extended and delayed release). In such aspects, the combination of the enteric barrier overlying the hydrophobic barrier provides for a delayed and then gradual release of the one or more vitamins and minerals from the nutrient layer of the controlled release beads of the composition over an extended period of time.

Other barrier coatings can be utilized, e.g., the barrier coatings described in U.S. Pat. No. 6,066,334 and U.S. Pat. No. 6,046,277, U.S. Pat. No. 6,046,277, U.S. Pat. No. 6,001,392, US2007/0215511, US2005/232986, US2005/232987 US2005/232993, US2005/266032, and US2003/009971. Barrier coatings may be applied by a number of traditional methods including, but no limited to, conventional coating procedures or fluid bed spraying. Methods for forming beads are described in U.S. Pat. No. 6,066,334 and U.S. Pat. No. 6,046,277, U.S. Pat. No. 6,046,277, U.S. Pat. No. 6,001,392, US2007/0215511, US2005/232986, US2005/232987 US2005/232993, US2005/266032, and US2003/009971.

The total amount of a barrier coating present may vary within a wide range, optionally from about 0.1% by weight to about 20% by weight, including about 1% to about 15% by weight, about 5% to about 15% by weight, about 2% to about 10% by weight, and about 2% by weight to about 7.5% by weight of the total composition, including about 1%, 2%, 5%, 7.5%, 10%, 15%, and 20% by weight and ranges encompassing and bordered by such amounts. The amount of a barrier coating component(s) present may depend, at least in part, upon the amount and identity of each of the other components present (e.g. the amounts and physical characteristics of the controlled release beads, including extended release beads, delayed release beads, or beads providing both extended and delayed release of the extended release beads, and any optional swellable polymer(s) and additives), and the identity and properties of the particular barrier coating component(s), with the object being to achieve a controlled release bead formulation which exhibits extended release, delayed release, or both extended and delayed release.

In some aspects, the controlled release beads, including extended release beads, delayed release beads, or beads providing both extended and delayed release, may include one or more swellable polymers that act to modify, prolong, and/or slow the release over time of the at the controlled release beads. A “swellable polymer” is a polymer that will swell in the presence of a dispersion medium, such as a fluid, optionally an aqueous fluid, optionally a digestive fluid of a mammal. Thus, swellable polymers are capable of absorbing water and physically swelling as a result, with the extent to which a polymer can swell being determined by the molecular weight or degree of crosslinking (for crosslinked polymers). The one or more swellable polymer is capable of swelling dimensionally unrestrained in upon contact with a dispersion medium, such as an aqueous medium. Suitable water-swellable polymers include those polymers that swell in a dimensionally unrestrained manner upon contact with water. Such polymers may also gradually erode over time. Examples of such polymers include polyalkylene oxides, such as polyethylene glycols, particularly high molecular weight polyethylene glycols; cellulose polymers and their derivatives including, but not limited to, methylcellulose, ethylcellulose (e.g. Surelease®, available from Colorcon as an aqueous ethyl cellulose dispersion containing water (70.6% w/w), ethylcellulose (18.8% w/w), ammonium hydroxide (4.4% w/w), a medium chain triglyceride (4.0% w/w), and oleic acid (2.2% w/w)), hydroxyalkyl celluloses, hydroxymethyl cellulose, hydroxyethyl cellulose, hydroxypropyl cellulose, hydroxypropyl methylcellulose (available from Dow Chemical Company), carboxymethylcellulose, microcrystalline cellulose (available from FMC); polysaccharides and their derivatives; chitosan; poly(vinyl alcohol); xanthan gum; maleic anhydride copolymers; poly(vinyl pyrrolidone); starch and starch-based polymers; maltodextrins; poly(2-ethyl-2-oxazoline); poly(ethyleneimine); polyurethane; hydrogels; crosslinked polyacrylic acids; poly(ethylene oxide); and combinations or blends of any of the foregoing. In certain aspects, the one or more swellable polymers may increase to a size sufficient to be retained in the stomach for an extended period of time. In aspects, the one or more swellable polymers are included in the nutrient layer of the controlled release beads.

When the optional one or more swellable polymers is present in the controlled release beads, the total amount present may vary within a wide range, preferably from about 0.1% by weight to about 50% by weight, including about 2% to about 40% by weight, about 10% to about 40% by weight, and about 2% by weight to about 20% by weight of the total composition, including about 5%, 10%, 15%, 20%, 30%, 40%, and 50% by weight, including any value or range therebetween. The amount of the one or more swellable polymer components present may depend, at least in part, upon the amount and identity of each of the other components present (the amounts and physical characteristics of one or more water soluble vitamins and/or minerals of the controlled release beads, and any barrier coatings and additives, as well as the identity and properties of the particular polymer(s), with the object being to achieve a controlled release bead formulation which exhibits extended release, delayed release, or both extended and delayed release.

In some aspects, the controlled release beads, including extended release beads, delayed release beads, or beads providing both extended and delayed release, may be milled or otherwise produced to achieve a desired size range. The particle size (maximum linear cross sectional dimension) of the controlled release beads, including extended release beads, delayed release beads, or beads providing both extended and delayed release, particle size can range from about 150 μm to about 2000 μm, or any value or range therebetween. In other aspects, the beads can be milled or passed through one or more sieves to provide a particle size ranging from about 400 μm to about 1700 μm, or any value or range therebetween. In other aspects, the beads can be milled or passed through one or more sieves to provide a particle size ranging from about 800 μm to about 1250 μm, or any value or range therebetween. These bead sizes may be determined using sieve analysis through a sieve shaker having USP standard wire mesh sieves conforming to ASTM specifications (e.g. 16, 20, 30, 40, 60, or 80 mesh screen, optionally a scree of 10 to 80 mesh).

In certain aspects the controlled release beads, including extended release beads, delayed release beads, or beads providing both extended and delayed release, optionally include one or more additives including but not limited to, e.g., one or more of a diluent, binder, lubricant, disintegrant, stabilizer, surfactant, glidant, sweetener, a preservative, sodium citrate; silica; flavoring agents, coloring agents, preservatives, or other components. The choice of which such materials to us, if any, and the amounts to be utilized are considered to be within the abilities of one of skilled in the art, in view of the disclosure herein.

Exemplary diluents may include, but are not limited to calcium carbonate, calcium phosphate dibasic, calcium phosphate tribasic, calcium sulfate, microcrystalline cellulose, microcrystalline silicified cellulose, powdered cellulose, dextrate, dextrose, fructose, lactitol, lactose anhydrous, lactose monohydrate, lactose dihydrate, lactose trihydrate, mannitol, sorbitol, starch, pregelatinized starch, sucrose, talc, xylitol, maltose, maltodextrin, maltitol, and combinations thereof.

Exemplary binders may include, but are not limited to, starch (including corn starch and pregelatinized starch), gelatin, sugars (including sucrose, glucose, dextrose and lactose), polyethylene glycol, waxes, and natural and synthetic gums, e.g., acacia sodium alginate, polyvinylpyrrolidone, cellulosic polymers (including hydroxypropyl cellulose, hydroxypropyl methylcellulose, methyl cellulose, microcrystalline cellulose, ethyl cellulose, hydroxyethyl cellulose, and the like), and Veegum. Examples of polyvinylpyrrolidone include povidone, copovidone and crospovidone.

Exemplary lubricants may include, but are not limited to magnesium stearate, calcium stearate, stearic acid, and hydrogenated vegetable oil (e.g. comprising hydrogenated and refined triglycerides of stearic and palmitic acids).

Exemplary disintegrants may include, but are not limited to starches, sodium starch glycolate, croscarmellose sodium, clays, celluloses, algins, gums, or crosslinked polymers (e.g., crosslinked polyvinylpyrrolidone), alginic acid, carbon dioxide, carboxymethylcellulose calcium, carboxymethylcellulose sodium, microcrystalline cellulose, powdered cellulose, croscarmelose sodium, crospovidone, sodium docusate, gaur gum, hydroxypropyl cellulose, methylcellulose, polacrilin potassium, poloxamer, povidone, sodium alginate, sodium glycine carbonate, sodium lauryl sulfate, pregelatinized starch, low-substituted hydroxypropyl cellulose.

Fillers include, for example, materials such as kaolin, powdered cellulose, and microcrystalline cellulose, as well as soluble materials such as mannitol, urea, sucrose, lactose, lactose monohydrate, dextrose, sodium chloride, and sorbitol.

Exemplary sweeteners may include those sweeteners well known in the art, including both natural and artificial sweeteners. Thus, exemplary sweeteners may include water-soluble sweetening agents such as monosaccharides, disaccharides, and polysaccharides such as xylose, ribose, glucose, mannose, galactose, fructose, high fructose corn syrup, dextrose, sucrose, sugar, maltose, partially hydrolyzed starch, or corn syrup solids and sugar alcohols such as sorbitol, xylitol, mannitol and mixtures thereof. Additional exemplary sweeteners include optionally sugar or sugar substitute (e.g. sucralose (1,6-Dichloro-1,6-dideoxy-β-D-fructofuranosyl-4-chloro-4-deoxy-α-D-galactopyranoside), aspartame, and the like.

Exemplary preservatives may include sodium benzoate, benzoic acid, potassium sorbate, salts of edetate (also known as salts of ethylenediaminetetraacetic acid, or EDTA, such as disodium EDTA), parabens (e.g., methyl, ethyl, propyl or butyl-hydroxybenzoates, etc.), and sorbic acid. Other chelating agents, e.g., nitrilotriacetic acid (NTA); ethylenediaminetetracetic acid (EDTA), hydroxyethylethylenediaminetriacetic acid (HEDTA), diethylenetriaminepentaacetic acid (DPTA), 1,2-Diaminopropanetetraacetic acid (1,2-PDTA); 1,3-Diaminopropanetetraacetic acid (1,3-PDTA); 2,2-ethylenedioxybis[ethyliminodi(acetic acid)] (EGTA); 1,10-bis(2-pyridylmethyl)-1,4,7,10-tetraazadecane (BPTETA); ethylenediamine (EDAMINE); Trans-1,2-diaminocyclohexane-N,N,N′,N′-tetraacetic acid (CDTA); ethylenediamine-N,N′-diacetate (EDDA); phenazine methosulphate (PMS); 2,6-Dichloroindophenol (DCPIP); Bis(carboxymethyl)diaza-18-crown-6 (CROWN); porphine; chlorophyll; dimercaprol (2,3-Dimercapto-1-propanol); citric acid; tartaric acid; fumaric acid; malic acid; and salts thereof can be utilized as preservatives. Each preservative must be evaluated in each formulation to assure the compatibility and efficacy of the preservative. Methods for evaluating the efficacy of preservatives in compositions and formulations are known and routine to those skilled in the art.

Exemplary flavoring agents may include both natural and artificial flavors, mints such as peppermint, menthol, artificial vanilla, chocolate, cinnamon, various fruit flavors, both individual and mixed, essential oils (i.e. thymol, eucalyptol, menthol and methyl salicylate) and the like.

The controlled release beads, including extended release beads, delayed release beads, or both extended and delayed release beads, of the composition can be manufactured using methods that are known in the art. Such methods include, but are not limited to, dry and wet granulation technology, including fluid bed granulation, high shear granulation, extrusion and spheronization, coating an inert core (including but not limited to, fluid bed coating an inert core), and spay drying layers over an inert core, as are known in the art.

In aspects, the immediate and controlled release nutrition and/or performance enhancing composition can further comprise an immediate release component, with the immediate release component comprising a performance enhancing component. The immediate release component is designed such that, upon ingestion, maximum exposure of said at least one performance enhancing component from the composition to body tissues occurs in the minimum period of time. As described herein, an “immediate release” component optionally releases at least one performance enhancing component in less than about 1 hr, in about 45 minutes, in about 30 minutes, in about 20 minutes, in about 10 minutes, in about 5 minutes, in about 3 minutes, in about 2 minutes, or as soon as about 1 minute.

In aspects, a performance enhancing component of the immediate release component comprises one or more water soluble vitamins, one or more water soluble minerals, one or more oil soluble vitamins, one or more oil soluble minerals, or any combination thereof. In certain aspects, the one or more water soluble vitamins, one or more water soluble minerals, or combinations thereof can comprise at least one of vitamin B1 (optionally in the form of thiamine mononitrate), vitamin B2 (optionally in the form of riboflavin), vitamin B3 (optionally in the form of niacin and/or inositol hexanicotinate), vitamin B5 (optionally in the form of pantothenic acid and/or calcium D-pantothenic acid), vitamin B6 (optionally in the form of pyridoxine HCl), folic acid (optionally in the form or folate), vitamin B12 (optionally in the form of methylcobalamin), vitamin C (optionally in the form of ascorbic acid), biotin, calcium, iron (optionally in the form of ferrous sulfate monohydrate and/or ferrous sulfate), phosphorus, sulfur, zinc (optionally in the form of zinc oxide), copper (optionally in the form of cupric oxide), iodine (optionally in the form of potassium iodine), manganese (optionally in the form of manganese gluconate), chromium (optionally in the form of chromium chelate), molybdenum (optionally in the form of molybdenum chelate), selenium (optionally in the form of sodium selenate), sensoril® ashwagandha (withania smnifera) (Root, Leaf), huperzine A 1% (huperzia serrata) (whole herb), alpha-GPC (alpha lycerylphosphorylcholine), cognizin® citicoline, saw palmetto serenoa repens (Fruit) (3-8% Free Fatty Acids), lycopene, citicoline, choline, fluoride, chloride, potassium, sodium, magnesium, boron (optionally in the form of boron amino acid chelate), and various mixtures or other combinations thereof. Water soluble vitamins and minerals are commercially available from sources known by those of skill in the art. In some aspects, the one or more oil soluble vitamins, one or more oil soluble minerals, or combinations thereof can comprise can comprise at least one of vitamin A (optionally as retinyl palmitate), vitamin D (optionally as cholecalciferol), vitamin E (optionally as D-alpha tocopherol), vitamin K (optionally as phytonadione), vitamin F and various mixtures or other combinations thereof. Oil soluble vitamins and/or minerals are commercially available from sources known by those of skill in the art.

In aspects, a performance enhancing component of the immediate release component comprises a performance enhancing supplement. As used herein, the term “performance enhancing supplement” encompasses a chemical composition that functions to enhance exercise performance, prevent reduction in exercise performance, prevent fatigue, or combinations thereof. In aspects, the performance enhancing supplement of the immediate release component comprises, illustratively, one or more of a: vitamin (e.g. vitamin B12 (optionally in the form of methycobalamin available from Anmar), vitamin B3 (optionally in the form of nicinaminde/nicotinamide available from DSM) among others); beta-alanine or derivative thereof (optionally CARNOSYN available from Natural Alternatives Intl.), mineral; protein; amino acid (e.g. arginine (optionally in the form of arginine silicate inositol available as Nitrosigine from Nutrition 21, or agmatine sulfate available from Parchem) glutamine (available from Kyowa Hakko), creatine (optionally in the form of creatine HCL available from Pharmline), carnitine, glycine, trimethyl glycine, tyrosine, leucine (available from Glanbia or Danisco), isoleucine (available from Glanbia), valine (available from Glanbia), citrulline (optionally in the form of citrulline malate available from Creative Compounds), among others or derivatives thereof optionally N-acetyl L-tyrosine (available from Cepham); branched-chain amino acids (optionally in the form of Pepform 2:1:1 BCAA containing a 2:1:1 ratio of leucine, isoleucine and valine, available from Glanbia); astragalus membranaceus and panax notoginseng carbohydrate (optionally in the form of Astragin available from N Liv Science); fatty acid (optionally essential fatty acid); stimulant illustratively caffeine (optionally 1,3,7-trimethylxanthine available from Mitsubishi), ephedrine, or forskholin; pyruvate; a citric acid cycle intermediate; betaine (optionally in the form of betaine anhydrous available from Danisco), norvaline (optionally in the form of L-novaline, available from Cepham), one or more plant components such as an essential oil or plant extract (illustratively citrus aurantium, grape seed extract, or piper nigrum (available from Indena)), ashwagandha extract (optionally KSM66 from Ixoreal), magnesium, boron, or a derivative of any of the foregoing. In certain aspects, the performance enhancing supplement of the immediate release component is an uncoated performance enhancing supplement. Thus, the immediate release performance enhancing supplement can function to maintain vasodilation during and after a workout, stimulate muscle synthesis and repair over an extending period of time, and/or prevent athletic fatigue, such as sustaining energy levels and avoiding a subsequent energy level crash, when consumed by a subject.

The performance enhancing component of the immediate release component is present to provide an in vivo concentration effective to function to improve nutrition, improve athletic performance, such as maintaining vasodilation during and after a workout and stimulating muscle synthesis and repair over an extending period of time, and/or preventing athletic fatigue, such as sustaining energy levels and avoiding a subsequent energy level crash. In certain aspects, performance enhancing component of the immediate release component is optionally present at a weight percent of the composition of about 5% to about 95%, or any value or range therebetween. For example, the performance enhancing component of the composition is optionally present at a weight percent of about 5% to about 15%, about 15% to about 25%, about 25% to about 35%, about 35% to about 45%, about 45% to about 55%, about 55% to about 65%, about 65% to about 75%, about 75% to about 85%, about 85% to about 95%, or any value or range therebetween.

In some aspects, the immediate release component comprising a performance enhancing component is provided as an outer, immediate release layer of the (b) controlled release beads, including extended release beads, delayed release beads, or beads providing both extended and delayed release. In some aspects, the outer, immediate release layer of the (b) controlled release beads (including extended release beads, delayed release beads, or beads providing both extended and delayed release) can be applied, e.g., as an aqueous suspension or dispersion, over a barrier coating of controlled release beads (including extended release beads, delayed release beads, or beads providing both extended and delayed release), and forms a separate layer thereon.

For example, in aspects, an immediate release component comprising a performance enhancing component is provided as an outer, immediate release layer overlying a barrier coating comprising a hydrophobic material that is overlying a nutrient layer or seal film layer and forms a separate layer thereon. In such aspects, the controlled release bead provides an immediate release of the performance enhancing component from the outer layer of the bead and subsequently for the gradual release of the one or more vitamins and minerals from the nutrient layer of the controlled release beads of the composition over an extended period of time. In other aspects, an immediate release component comprising a performance enhancing component is provided as an outer, immediate release layer over an enteric barrier that is overlying a nutrient layer or seal film layer and forms a separate layer thereon. In such aspects, the controlled release bead provides for an immediate release of the immediate release component and subsequently for the delayed release of the one or more vitamins and minerals from the nutrient layer of the controlled release beads of the composition. In further aspects, an immediate release component comprising a performance enhancing component is provided as an outer, immediate release layer over an enteric barrier coating overlying a barrier coating comprising a hydrophobic material and forms a separate layer thereon, with the hydrophobic barrier overlying a nutrient layer or a seal film layer of the controlled release beads. In such aspects, the controlled release bead provides an immediate release of the immediate release component and subsequently for the delayed and then gradual release of the one or more vitamins and minerals from the nutrient layer of the controlled release beads of the composition over an extended period of time.

In some aspects, the immediate release component comprising a performance enhancing component is provided as immediate release beads. In aspects, the immediate release beads are incorporated into said one or more edible oils of the oil phase. In certain aspects, the immediate release beads comprise an inert core and a performance enhancing layer coating the inert core. The inert core of the immediate release beads can comprise at least one of celluloses, starches, saccharides, or mixtures thereof. In certain aspects, the inert core of the immediate release beads is spherical. In other aspects, the inert core of the immediate release beads is a sugar sphere, as are known in the art and commercially available.

In some aspects, the performance enhancing layer of the immediate release beads comprises a performance enhancing component, as previously described. Thus, in aspects, a performance enhancing component of the performance enhancing layer of the immediate release beads comprises a performance enhancing supplement as previously described. Additionally, in aspects, the performance enhancing component of the performance enhancing layer of the immediate release beads comprises one or more vitamins, one or more minerals, or a combination thereof as previously described (e.g., one or more water soluble vitamins, one or more water soluble minerals, one or more oil soluble vitamins, one or more oil soluble minerals, or any combination thereof). In aspects, the performance enhancing layer comprising a performance enhancing component can be applied, e.g., as an aqueous suspension or dispersion, over the inert core, a binding layer, or a seal layer of the immediate release beads, and forms a separate layer thereon.

In certain aspects, the immediate release beads can further comprise a seal film layer. In further aspects, the seal film layer comprises a sealer. Suitable sealers include, but are not limited to, celluloses such as hydroxypropylmethylcellulose, hydroxypropyl cellulose, microcrystalline cellulose and carboxymethyl-cellulose sodium, polyvinylpyrrolidone, polyethylene glycol, starches, and combinations thereof. In certain aspects, the seal film layer coats the performance enhancing layer. In further aspects, the seal film layer directly coats the performance enhancing layer. In one aspect, the seal layer can be applied, e.g., as an aqueous suspension or dispersion, over the inert core, a performance enhancing layer, or a binding layer of the immediate release beads, and forms a separate layer thereon.

In certain aspects, the immediate release bead further comprises at least one binder. Binders are substances which are useful in holding other excipients or active ingredients together as solids. Suitable binders include, but are not limited to, celluloses such as hydroxypropylmethylcellulose, hydroxypropyl cellulose, microcrystalline cellulose and carboxymethyl-cellulose sodium, polyvinylpyrrolidone, polyethylene glycol, starches, and combinations thereof. In certain aspects, the at least one binder is included in the performance enhancing layer. In other aspects, the at least one binder can be included in a binder layer of the immediate release beads. In one aspect, the binding layer can be applied, e.g., as an aqueous suspension or dispersion, over the inert core, a performance enhancing layer, or a seal layer of the immediate release beads, and forms a separate layer thereon.

The immediate release beads comprising the at least one performance enhancing component of the composition can be manufactured using methods that are known in the art. Such methods include, but are not limited to, dry and wet granulation technology, including fluid bed granulation, high shear granulation, extrusion and spheronization, coating an inert core (including but not limited to, fluid bed coating an inert core), and spay drying layers over an inert core, as are known in the art.

In some aspects, the immediate release beads may be milled to achieve a desired size range. The particle size of the immediate release beads can range from about 150 μm to about 2000 μm, or any value or range therebetween. In other aspects, the beads can be milled or passed through a sieve to provide a particle size ranging from about 400 μm to about 1700 μm, or any value or range therebetween. In other aspects, the beads can be milled or passed through a sieve to provide a particle size ranging from about 800 μm to about 1250 μm, or any value or range therebetween. These bead sizes may be determined using sieve analysis through a sieve shaker having USP standard wire mesh sieves conforming to ASTM specifications (e.g. 16, 20, 30, 40, 60, or 80 mesh screen, optionally a screen of 10 to 80 mesh).

In certain aspects, the immediate release beads comprising a performance enhancing component optionally includes one or more excipients, including but not limited to, e.g., one or more of a sweetener, a preservative, sodium citrate; silica; flavorants, colorants, preservatives, or other components. The choice of which such materials to use, if any, and the amounts to be utilized are considered to be within the abilities of one of skilled in the art, in view of the disclosure herein.

Exemplary sweeteners may include those sweeteners well known in the art, including both natural and artificial sweeteners. Thus, exemplary sweeteners may include water-soluble sweetening agents such as monosaccharides, disaccharides, and polysaccharides such as xylose, ribose, glucose, mannose, galactose, fructose, high fructose corn syrup, dextrose, sucrose, sugar, maltose, partially hydrolyzed starch, or corn syrup solids and sugar alcohols such as sorbitol, xylitol, mannitol and mixtures thereof. Additional exemplary sweeteners include optionally sugar or sugar substitute (e.g. sucralose (1,6-Dichloro-1,6-dideoxy-β-D-fructofuranosyl-4-chloro-4-deoxy-α-D-galactopyranoside), aspartame, and the like.

Exemplary preservatives may include sodium benzoate, benzoic acid, potassium sorbate, salts of edetate (also known as salts of ethylenediaminetetraacetic acid, or EDTA, such as disodium EDTA), parabens (e.g., methyl, ethyl, propyl or butyl-hydroxybenzoates, etc.), and sorbic acid. Other chelating agents, e.g., nitrilotriacetic acid (NTA); ethylenediaminetetracetic acid (EDTA), hydroxyethylethylenediaminetriacetic acid (HEDTA), diethylenetriaminepentaacetic acid (DPTA), 1,2-Diaminopropanetetraacetic acid (1,2-PDTA); 1,3-Diaminopropanetetraacetic acid (1,3-PDTA); 2,2-ethylenedioxybis[ethyliminodi(acetic acid)] (EGTA); 1,10-bis(2-pyridylmethyl)-1,4,7,10-tetraazadecane (BPTETA); ethylenediamine (EDAMINE); Trans-1,2-diaminocyclohexane-N,N,N′,N′-tetraacetic acid (CDTA); ethylenediamine-N,N′-diacetate (EDDA); phenazine methosulphate (PMS); 2,6-Dichloroindophenol (DCPIP); Bis(carboxymethyl)diaza-18-crown-6 (CROWN); porphine; chlorophyll; dimercaprol (2,3-Dimercapto-1-propanol); citric acid; tartaric acid; fumaric acid; malic acid; and salts thereof can be utilized as preservatives. Each preservative must be evaluated in each formulation to assure the compatibility and efficacy of the preservative. Methods for evaluating the efficacy of preservatives in compositions and formulations are known to those skilled in the art.

Exemplary flavorings may include both natural and artificial flavors, and mints such as peppermint, menthol, artificial vanilla, chocolate, cinnamon, various fruit flavors, both individual and mixed, essential oils (i.e. thymol, eucalyptol, menthol and methyl salicylate) and the like.

The instantly-disclosed compositions can be administered by any desirable route. Optionally, the composition is administered orally. An administration time is optionally before, during, or following exercise. Optionally, the composition is administered orally prior to exercise or during exercise. In certain aspects, the composition is administered once a day. The oil phase comprising one or more edible oils and optionally one or more oil soluble vitamins, one or more minerals, or combinations thereof, the controlled release beads comprising one or more vitamins, one or more minerals, or combinations thereof, and optionally the immediate release component comprising one or more performance enhancing components of the instant compositions are subsequently mixed to form an oral dosage form.

In aspects, the nutrition and/or performance enhancing immediate and extended release composition is mixed and contained within a capsule, optionally forming a two-piece liquid capsule, or in a softgel. Suitable capsules are known to those of skill in the art, and include, but are not limited to, capsules made from gelatin, hydroxypropyl methylcellulose, gellan gum, pullulan, or combinations thereof. In aspects that utilize a two-piece liquid capsule, the capsule may be sealed by means known to those of skill in the art, including but not limited to, traditional banding and LEMS® Technology.

As such, processes are provided for enhancing nutrition and/or athletic performance or preventing fatigue that include administering a the instantly-disclosed composition(s) as provided to a mammalian subject, optionally a human, wherein the administration is performed at a time suitable for enhancing athletic performance or preventing fatigue. Additionally, processes are provided for maintaining vasodilation during and after a workout, stimulating muscle synthesis and repair over an extending period of time, and/or preventing athletic fatigue, such as sustaining energy levels and avoiding a subsequent energy level crash, that include administering the instantly-disclosed immediate and controlled release performance enhancing supplement compositions. An administration time is optionally from 0 to 30 minutes prior to exercise or other athletic activity, during athletic activity, or combinations thereof.

The foregoing description is illustrative of particular aspects of the invention, but is a limitation upon the practice thereof. In order that various aspects may be more readily understood, reference is made to the following examples which are intended to illustrate various aspects, but do not limit the scope thereof.

### EXAMPLES

### Example 1

### Immediate and Controlled Release Composition

TABLE A
Exemplary Fish Oil and Oil Soluble
Vitamin and Minerals of Oil Phase

| | Weight % of |
|---|---|
| Ingredient | Oil Phase |
| Concentrated Fish Oil (providing 340 mg EPA/240 | 0%-100% |
| mg/DHA) as (Fish Oil 34/24 TG KD-PUR ®) | |
| Vitamin E (as D-Alpha Tcoherols 1300 IU/g) | 0%-20% |
| Parsley CO₂ Extract | 0%-10% |
| Vitamin D (as Cholecalciferol 1000 IU/mg) | 0%-10% |
| Vitamin A (as Retinyl Palmitate 1.7M IU/g) | 0%-10% |
| Pumpkin Seed Oil | 0%-10% |

TABLE B
Exemplary Vitamin and Minerals of Controlled Release Beads

| | Weight % of Controlled |
|---|---|
| Ingredient | Release Beads |
| Vitamin C (as Ascorbic Acid) | 0%-30% |
| Vitamin B1 (as Thiamine Mononitrate) | 0%-10% |
| Vitamin B2 (as Riboflavin) | 0%-10% |
| Vitamin B3/Niacin (as | 0%-20% |
| Inisitol Hexanicotinate)) | |
| Vitamin B6 (as Pyridoxine HCl) | 0%-10% |
| Folic Acid (as Folate) | 0%-5% |
| Vitamin B12 (as Methylcobalamin) | 0%-5% |
| Biotin | 0%-5% |
| Vitamin K (as Phytonadione) | 0%-5% |
| Vitamin B5/Pantothenic Acid | 0%-5% |
| (as Calcium D-Pantothenic Acid) | |
| Iron (as Ferrous Sulfate) | 0%-10% |
| Zinc (as Zinc Oxide) | 0%-10% |
| Copper (as Cupric Oxide) | 0%-5% |
| Iodine (as Potassium Iodide) | 0%-5% |
| Manganese (as Manganese Gluconate) | 0%-10% |
| Chromium (as Chromium Chelate) | 0%-5% |
| Molybdenum (as Molybdenum Chelate) | 0%-5% |
| Selenium (as Sodium Selenate) | 0%-5% |
| Sensoril ® Ashwagandha (Withania | 0%-30% |
| somnifera) (Root, Leaf) | |
| Huperzine A 1%, Huperzia serrata | 0%-10% |
| (Whole Herb) | |
| Alpha-GPC | 0%-5% |
| (Alpha Glycerylphosphorylcholine) | |
| Cognizin ® Citicoline | 0%-10% |
| Saw Palmetto, Serenoa repens (Fruit) | 0%-10% |
| (3-8% Free Fatty Acids) | |
| Lycopene | 0%-5% |
| Boron (as Boron Amino Acid Chelate) | 0%-10% |

Other exemplary ingredients in the Controlled Release Beads include: Talc, Dicalium Phosphate, Sugar (used as, e.g., as a sugar sphere/inert core), Pharmaceutical Glaze (a denatured alcoholic solution of Shellac, used as, e.g., a barrier coating), Polyvinylpyrrolidone (used as, e.g., a binder), Starch, Mannitol, Titanium Dioxide, FD&C Red #40 Lake, FD&C Yellow #5 Lake+, Corn Oil, Tocopherols, and Sodium Ascorbate.

TABLE C
Exemplary Performance Enhancing Components of Immediate
Release Component (including Immediate Release Beads)

| | Weight % of Controlled |
|---|---|
| Ingredient | Release Beads |
| Vitamin C (as Ascorbic Acid) | 0%-30% |
| Vitamin B1 (as Thiamine Mononitrate) | 0%-10% |
| Vitamin B2 (as Riboflavin) | 0%-10% |
| Vitamin B3/Niacin (as | 0%-20% |
| Inisitol Hexanicotinate)) | |
| Vitamin B6 (as Pyridoxine HCl) | 0%-10% |
| Folic Acid (as Folate) | 0%-5% |
| Vitamin B12 (as Methylcobalamin) | 0%-5% |
| Biotin | 0%-5% |
| Vitamin K (as Phytonadione) | 0%-5% |
| Vitamin B5/Pantothenic Acid | 0%-5% |
| (as Calcium D-Pantothenic Acid) | |
| Iron (as Ferrous Sulfate) | 0%-10% |
| Zinc (as Zinc Oxide) | 0%-10% |
| Copper (as Cupric Oxide) | 0%-5% |
| Iodine (as Potassium Iodide) | 0%-5% |
| Manganese (as Manganese Gluconate) | 0%-10% |
| Chromium (as Chromium Chelate) | 0%-5% |
| Molybdenum (as Molybdenum Chelate) | 0%-5% |
| Selenium (as Sodium Selenate) | 0%-5% |
| Sensoril ® Ashwagandha (Withania | 0%-30% |
| somnifera) (Root, Leaf) | |
| Huperzine A 1%, Huperzia serrata | 0%-10% |
| (Whole Herb) | |
| Alpha-GPC | 0%-5% |
| (Alpha Glycerylphosphorylcholine) | |
| Cognizin ® Citicoline | 0%-10% |
| Saw Palmetto, Serenoa repens (Fruit) | 0%-10% |
| (3-8% Free Fatty Acids) | |
| Lycopene | 0%-5% |
| Boron (as Boron Amino Acid Chelate) | 0%-10% |

Other exemplary ingredients in the Immediate Release Beads include: Talc, Dicalium Phosphate, Sugar (used as, e.g., as a sugar sphere/inert core), Polyvinylpyrrolidone (used as, e.g., a binder), Starch, Mannitol, Titanium Dioxide, FD&C Red #40 Lake, FD&C Yellow #5 Lake+, Corn Oil, Tocopherols, and Sodium Ascorbate.

TABLE D
Exemplary Controlled Release Bead Swellable Polymers

| | Weight % of Controlled |
|---|---|
| Ingredient | Release Beads |
| Hydroxypropyl methylcellulose | 0%-25% |
| Microcrystalline cellulose | 0%-25% |
| Ethylcellulose | 0%-25% |
| Methylcellulose | 0%-25% |
| Gums | 0%-25% |

TABLE E
Exemplary Controlled Release Bead Barrier Coatings

| | Weight % of Controlled |
|---|---|
| Ingredient | Release Beads |
| Ethylcellulose | 0%-10% |
| Shellac | 0%-10% |
| Hydroxypropyl methylcellulose | 0%-10% |

The oil phase comprising one or more fish oils and one or more oil soluble vitamins and/or minerals, the controlled release beads comprising one or more vitamins and/or minerals, and optionally the immediate release component (e.g. immediate release beads) comprising one or more performance enhancing components of the instant compositions are subsequently mixed to form to form an oral dosage form, optionally in a two-piece liquid capsule.

Various modifications of the present invention, in addition to those shown and described herein, will be apparent to those skilled in the art of the above description. Such modifications are also intended to fall within the scope of the appended claims.

It is appreciated that all reagents or components are obtainable from commercial sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference in its entirety.

The foregoing description is illustrative of particular aspects of the invention, but is not meant to be a limitation upon the practice thereof.

1. A nutrition enhancing composition comprising:
(a) an oil phase, said oil phase comprising:
one or more edible oils; and
optionally one or more oil soluble vitamins, one or more oil soluble minerals, or a combination thereof;
beads comprising one or more vitamins, one or more minerals, or a combination thereof, wherein the beads are incorporated into said one or more edible oils;
(c) optionally an immediate release component comprising a performance enhancing component.

2. The nutrition enhancing composition of claim 1, wherein the beads comprise an inert core and a nutrient layer coating the inert core, wherein the nutrient layer comprises one or more vitamins, one or more minerals, or a combination thereof.

3. The nutrition enhancing composition of claim 1, wherein the beads further comprise an seal film layer, wherein the seal film layer comprises a sealer and the seal film layer coats the nutrient layer.

4. The nutrition enhancing composition of claim 1, wherein the beads further comprise a barrier coating layer.

5. The nutrition enhancing composition of claim 1, wherein the further comprise one or more swellable polymers.

6. The nutrition enhancing composition of claim 1, wherein the composition further comprises at least one excipient selected from the group consisting of a diluent, a binder, a lubricant, a disintegrant, a flavoring agent, a coloring agent, a stabilizer, a surfactant, a glidant, a preservative, and a sweetener.

7. The nutrition enhancing composition of claim 6 wherein the beads further comprise at least one excipient selected from the group consisting of a diluent, a binder, a lubricant, a disintegrant, a flavoring agent, a coloring agent, a stabilizer, a surfactant, a glidant, a preservative, and a sweetener.

8. The nutrition enhancing composition of claim 1, wherein the particle size of beads is from about 400 μm to about 1700 μm.

9. The nutrition enhancing composition of claim 1, wherein the particle size of beads is from about 800 μm to about 1250 μm.

10. The nutrition enhancing composition of claim 1, wherein the beads further comprise a binder.

11. The nutrition enhancing composition of claim 10, wherein the nutritional layer of the beads further comprises a binder.

12. The nutrition enhancing composition of claim 1, wherein the inert core of the beads comprises at least one of celluloses, starches, saccharides, or mixtures thereof.

13. The nutrition enhancing composition of claim 1, wherein the one or more edible oils comprises a fish oil, flax seed oil, evening primrose oil, borage seed oil, medium chain triglycerides, arachidonic acid, lecithin, safflower oil/CLA, or any combination thereof.

14. The nutrition enhancing composition of claim 1, wherein the one or more vitamins, the one or more minerals or a combination thereof of the beads comprises one or more water soluble vitamins, one or more water soluble minerals, one or more oil soluble vitamins, one or more oil soluble minerals, or any combination thereof.

15. The nutrition enhancing composition of claim 14, herein the one or more oil soluble vitamins comprise at least one of Vitamin A, Vitamin D, Vitamin E, Vitamin K, Vitamin F, or any combination thereof.

16. The nutrition enhancing composition of claim 14, wherein the one or more water soluble vitamins comprises at least one of Vitamin B1, Vitamin B2, Vitamin B3, Vitamin B5, Vitamin B6, Folic Acid, Vitamin B12, vitamin C, or any combination thereof.

17. The nutrition enhancing composition of claim 14, wherein the one or more water soluble minerals comprises at least one of biotin, calcium, iron, phosphorus, sulfur, zinc, copper, iodine, manganese, chromium, molybdenum, boron, magnesium, selenium, choline, fluoride, chloride, potassium, sodium, or any combination thereof.

18. The nutrition enhancing composition of claim 1, wherein the bead comprises at at least one performance enhancing component, the performance enhancing component comprising at least one of a vitamin, a mineral, protein, creatine, an amino acid, a carbohydrate, a fatty acid, a stimulant, pyruvate, a citric acid cycle intermediate, or any combination thereof.

19. (canceled)

20. The nutrition enhancing composition of claim 1, wherein the one or more edible oils comprise an omega-3 fatty acid.

21. The nutrition enhancing composition of claim 20, wherein the omega-3 fatty acid comprises at least one of docosahexaneoic acid and eicosapentaenoic acid.

22. The nutrition enhancing composition of claim 1, wherein the composition is in the form of a liquid capsule.

23. A process for enhancing nutrition in a subject comprising:
administering to the subject a nutrition enhancing composition, the composition comprising:
(a) an oil phase, said oil phase comprising:
one or more edible oils; and
optionally one or more oil soluble vitamins, one or more oil soluble minerals, or a combination thereof;
(b) beads comprising one or more vitamins, one or more minerals, or a combination thereof, wherein the controlled release beads are incorporated into said one or more edible oils; and
(c) optionally an immediate release component comprising a performance enhancing component; and
enhancing nutrition in said subject by said step of administering.

24-64. (canceled)

65. A nutrition enhancing composition comprising:
(a) an oil phase, said oil phase comprising:
one or more fish oils, and
one or more oil soluble vitamins, one or more oil soluble minerals, or a combination thereof;
(b) beads comprising one or snore water soluble vitamins, one or more water soluble minerals, or a combination thereof, wherein the beads are incorporated into said one or more fish oils;
the oil phase and the beads within a capsule.

66. The nutrition enhancing composition of claim 65 wherein said fish oil is an algae oil.

67. The nutrition enhancing composition of claim 65 wherein said oil soluble vitamins comprise Vitamin D, Vitamin E, Vitamin K, or combinations thereof.

68. The nutrition enhancing composition of claim 65 wherein the one or more water soluble minerals comprise magnesium, boron, or combinations thereof.
